(19) United States
(12) Patent Application Publication
(10) Pub. No.: US 2006/0207247 A1
(43) Pub. Date: Sep. 21, 2006

(54) Actuator

(75) Inventors: Shigekazu Nagai, Adachi-ku (JP); Akio Saitoh, Kawaguchi-shi (JP); Masahiko Someya, Ryugasaki-shi (JP); Masaru Saitoh, Mitsukaido-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/377,407

(22) Filed: Mar. 17, 2006

(30) Foreign Application Priority Data
Mar. 18, 2005 (JP) 2005-80552

(51) Int. Cl. F16D 31/02

(52) U.S. Cl. 60/413

(57) ABSTRACT

An actuator comprises a driving section driven and rotated by a supplied current, a pump mechanism driven by a driving force supplied from the driving section to suck and discharge pressure oil, and a cylinder mechanism having a piston displaceable by the pressure oil supplied from the pump mechanism. When a pressure of the pressure oil is at or greater than a predetermined value in the cylinder mechanism, a relief valve provided in the pump mechanism is opened to thereby discharge the pressure oil into a pressure oil-charging chamber of the pump mechanism. Pressure within a first or second cylinder chamber of the cylinder mechanism and into which the pressure oil is introduced is maintained substantially constant.

### BACKGROUND OF THE INVENTION

1. Field of the Invention

The present invention relates to an actuator capable of operating a displacement member of a driving mechanism, so as to move back and forth under action of a pressure fluid supplied from a pump mechanism, while driving and rotating the pump mechanism by means of a driving section.

2. Description of the Related Art

An actuator, which is driven by the aid of a pressure fluid (for example, a pressure oil), has been hitherto used, for example, in order to transport or position a workpiece.

A hydraulic actuator, which is disclosed, for example, in U.S. Pat. Nos. 3,902,318, 3,928,968, and 4,630,441, comprises a motor driven by a current, a hydraulic pump that discharges operation oil under a driving action of the motor, and a cylinder having a piston and a piston rod therein, which are displaceable in an axial direction by the operation oil. In the hydraulic actuator, the hydraulic pump is driven and rotated in accordance with rotation of the motor, and operation oil is supplied into the cylinder via a hydraulic passage formed in the hydraulic pump by displacement of a set of pistons. Accordingly, the piston is pressed by the operation oil and displaced in the axial direction.

On the other hand, in the electric actuator disclosed in U.S. Pat. No. 4,630,441, an accumulator in which operation oil is charged is connected to the electric actuator, wherein operation oil is supplied from the accumulator to a hydraulic pump.

The actuators disclosed in U.S. Pat. Nos. 3,902,318, 3,928,968, and 4,630,441 are used occasionally for pressing a piston rod so as to abut against a workpiece, utilizing a displacement force of the piston brought about by pressure of the operation oil, so that the workpiece may be retained at a predetermined position for a certain period of time.

In general, however, in the case of actuators based on the use of operation oil, an oil pressure or a hydraulic pressure of the operation oil lowers gradually over time after initial retention of the workpiece, due to causes such as small amounts of leakage of operation oil from the hydraulic pump, whereby the pressing force exerted on the workpiece is consequently lowered. Therefore, the actuator must be provided with a retaining mechanism, which avoids decreases in pressure of the operation oil, and which makes it possible to retain the workpiece at a substantially constant pressure.

For example, a retaining mechanism may be provided for the actuator, which mechanically retains the operation oil pressure, to thereby suppress a decrease in operation oil pressure in the hydraulic pump. However, if a retaining mechanism is provided as described above, then the actuator becomes large in size and a larger installation space is required, and consequently, the cost of the actuator increases.

On the other hand, an arrangement may be conceived in which a pressure-detecting section is provided for detecting the pressure of the operation oil. When a decrease in operation oil pressure is detected in the cylinder, a detection signal is output to a control unit. A control signal is provided by the control unit to subject the motor to a feedback control, so that the motor is driven at a required amount of rotation, in order to increase the supply of operation oil from the hydraulic pump. Accordingly, decrease in pressure of the operation oil can be suppressed. However, in this case, it is necessary to provide a pressure-detecting section and a control unit. Therefore, the cost of the apparatus is consequently increased, and additional space must be provided for installation of the control unit.

Further, an arrangement may be conceived in which the hydraulic pump is constantly driven at a high number of revolutions, in order to increase the flow rate of operation oil supplied from the hydraulic pump to the cylinder so as to be greater than a desired flow rate. In this way, a decrease in operation oil pressure may also be avoided. However, in this case, it is necessary that excessive operation oil supplied to the cylinder be returned again to the hydraulic pump. Therefore, a wasteful amount of energy is required for operating the actuator.

### SUMMARY OF THE INVENTION

A general object of the present invention is to provide an actuator having a simple structure, in which a driving force of a driving section may be transmitted efficiently to a driving mechanism, and in which an output control for the driving mechanism can be performed highly accurately.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a longitudinal sectional view illustrating an actuator according to a first embodiment of the present invention;

FIG. 2 is a magnified longitudinal sectional view illustrating a pump mechanism of the actuator shown in FIG. 1;

FIG. 3 is a sectional view taken along line III-III in FIG. 1;

FIG. 4 is a sectional view taken along line IV-IV in FIG. 1;

FIG. 5 is a magnified vertical sectional view illustrating features in the vicinity of a switching mechanism shown in FIG. 4;

FIG. 6 is a sectional view taken along line VI-VI in FIG. 1;

FIG. 7 is a schematic circuit diagram illustrating pressure oil flow routes through the actuator shown in FIG. 1;

FIG. 8 is characteristic curves illustrating the relationship between temperature and kinematic viscosity, in relation to cases in which mineral oil and silicone oil are applied respectively as pressure oils in the pump mechanism;

FIG. 9 is a magnified longitudinal sectional view illustrating an actuator according to a first modified embodiment, in which a piston of a cylinder mechanism is provided with a bypass passage communicating between a first cylinder chamber and a second cylinder chamber;

FIG. 10 is a magnified lateral sectional view illustrating an actuator according to a second modified embodiment, which is provided with a bypass passage communicating between a first cylinder passage and a second cylinder passage of a cylinder mechanism;

FIG. 11 is a magnified longitudinal sectional view illustrating an actuator according to a third modified embodiment, which is provided with bypass passages communicating between a pressure oil-charging chamber and first and second passages of a pump mechanism;

FIG. 12 is a magnified vertical sectional view illustrating an actuator according to a fourth modified embodiment, in which throttle sections are provided within valve sections of a pair of relief valves respectively;

FIG. 13 is a magnified vertical sectional view illustrating an actuator according to a fifth modified embodiment, in which slits are formed on first and second valves of a switching mechanism, and first and second through-holes and a supply passage communicate with each other via the slits;

FIG. 14 is an exploded perspective view illustrating the first and second valves shown in FIG. 13;

FIG. 15 is a magnified vertical sectional view illustrating an arrangement in which the first and second valves of the switching mechanism shown in FIG. 5 are changed from shuttle valves to spherical check valves;

FIG. 16 is a longitudinal sectional view illustrating an actuator according to a second embodiment of the present invention;

FIG. 17 is a longitudinal sectional view illustrating an actuator according to a third embodiment of the present invention; and

FIG. 18 is a sectional view taken along line XVIII-XVIII shown in FIG. 17.

### DESCRIPTION OF THE PREFERRED EMBODIMENTS

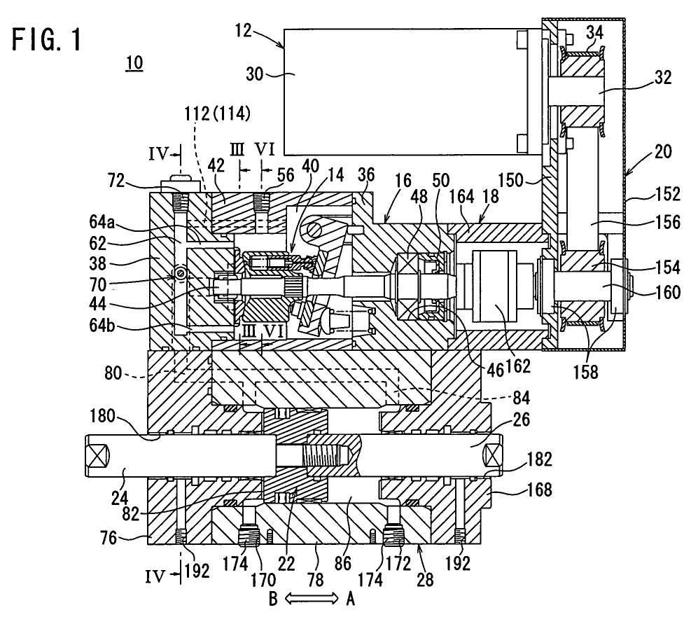

With reference to FIG. 1, reference numeral 10 indicates an actuator according to a first embodiment of the present invention.

As shown in FIG. 1, the actuator 10 comprises a driving section 12, which is driven and rotated by a current, a pump mechanism 16 provided substantially in parallel to the driving section 12 and having a suction/discharge section 14 that is energized/deenergized under a driving action of the driving section 12, a power transmission mechanism 20 for transmitting the driving force supplied from the driving section 12 via a coupling section 18 to the pump mechanism 16, and a cylinder mechanism (driving mechanism) 28 provided integrally on the side of the pump mechanism 16. The cylinder mechanism 28 includes a piston (displacement member) 22, which is displaceable in an axial direction in accordance with the supply of a pressure oil, and first and second piston rods 24, 26.

A synthetic operation oil, having a high viscosity and a high viscosity index, and which exhibits a small viscosity change with respect to changes in temperature, is used as the pressure oil. In particular, most appropriately, a synthetic operation oil containing no zinc should be used. That is, when pressure oil formed from a synthetic oil having high viscosity is used, it is possible to avoid leakage of the pressure oil from the pump mechanism 16. When the pressure oil has a high viscosity index, viscosity changes in the pressure oil, caused by changes in the atmospheric temperature at which the actuator 10 is used, can be suppressed. Therefore, the pump mechanism 16 can always be driven smoothly.

The driving section 12 is composed of, for example, a rotary driving source 30 such as an AC servo motor. The driving section 12 is connected to an unillustrated control unit, wherein the driving section 12 is driven and rotated in accordance with a control signal supplied from the control unit. A drive shaft 32 is provided, which protrudes at one end of the rotary driving source 30. The drive shaft 32 is rotated in an integrated manner under a rotary action of the rotary driving source 30. A first pulley 34 of the power transmission mechanism 20 (described later on) is installed on the drive shaft 32.

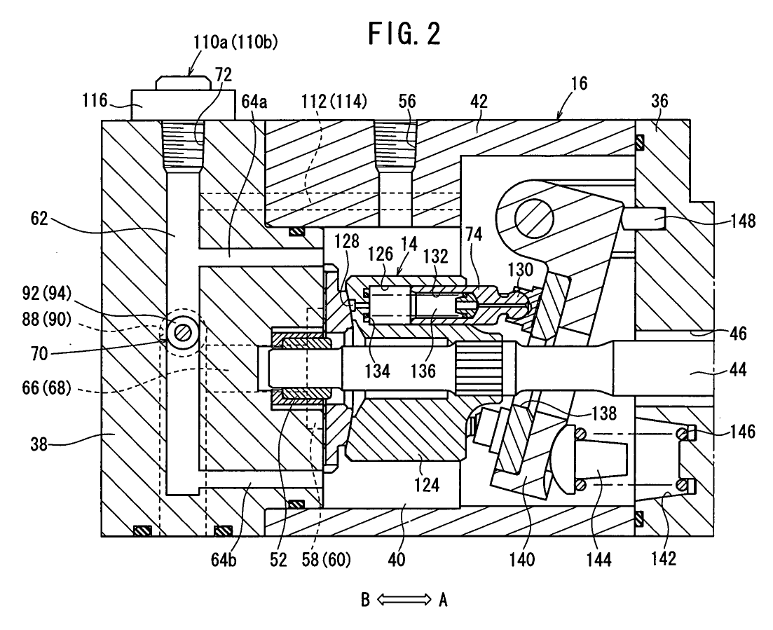

The pump mechanism 16 comprises an axial pump, which exhibits only a small amount of leakage of the pressure oil charged therein. As shown in FIG. 2, the pump mechanism 16 includes a pump body 36, which is connected to the power transmission mechanism 20 via a coupling section 18 (see FIG. 1), and a casing 42 having one end thereof connected to the pump body 36 and the other end thereof tightly closed by an end block 38, in order to form a pressure oil-charging chamber (retaining section) 40 therein. A rotary shaft 44 penetrates into the pressure oil-charging chamber 40 through the pump body 36. The suction/discharge section 14 is provided on the rotary shaft 44 and rotates integrally with the rotary shaft 44.

An insertion hole 46 is formed through the pump body 36, penetrating therethrough in the axial direction. One end of the rotary shaft 44 is rotatably supported by a shaft packing 50 and a bearing 48 installed in the insertion hole 46 (see FIG. 1). The other end of the rotary shaft 44 is rotatably supported by a bearing 52 installed in the end block 38.

A first supply port 56 is provided in the casing 42, which communicates with the pressure oil-charging chamber 40 formed in the casing 42. A connection pipe (not shown) is connected to the first supply port 56. More specifically, pressure oil is charged into the pressure oil-charging chamber 40 via the first supply port 56 from an unillustrated pressure oil supply source. Further, pressure oil contained in the pressure oil-charging chamber 40 is discharged to the outside via the first supply port 56, wherein the first supply port 56 is open to atmospheric air via the connection pipe. However, for example, a compressing unit (pressure-increasing mechanism) such as a supercharger may be connected to the connection pipe, and pressure oil may be supplied via the compressing unit so as to increase the pressure of the pressure oil in the pressure oil-charging chamber 40. The compressing unit need not necessarily be connected to the first supply port 56. For example, the compressing unit may also be connected to a supply passage 62.

When a compressing unit is connected to the first supply port 56 so as to increase the pressure of the pressure oil, the pressure of the pressure fluid may be increased, for example, within the pressure oil-charging chamber 40, the first and second passages 66, 68, the supply passage 62, and the first and second cylinder passages 80, 84 that communicate with the first supply port 56. As a result, even when a negative pressure is generated in the actuator 10, it is possible to avoid the occurrence of cavitation. Therefore is possible to avoid the generation of unusual sounds, along with decreases in volumetric efficiency in the pump mechanism 16, which otherwise would be caused by such cavitation.

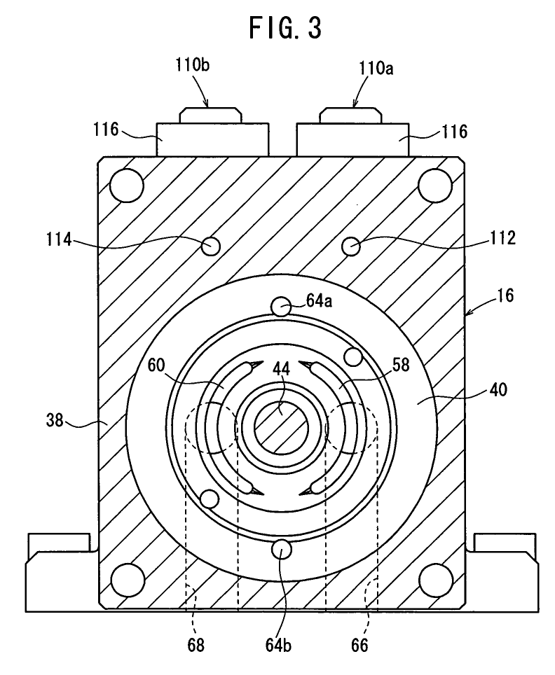

A substantially central portion of the end block 38 is inserted into the casing 42. The end block 38 includes a bearing 52, which supports the rotary shaft 44 of the pump mechanism 16, and a pair of first and second holes 58, 60 formed radially outwardly with respect to the bearing 52 (see FIG. 3). The first and second holes 58, 60 are formed at positions opposed to the suction/discharge section 14 provided in the casing 42.

Further, the end block 38 includes a supply passage 62, which extends toward the cylinder mechanism 28 substantially perpendicularly to the axis of the end block 38, a pair of communication passages 64a, 64b between the supply passage 62 and the pressure oil-charging chamber 40, a pair of first and second passages (flow passages) 66, 68 that communicate respectively with the first and second holes 58, 60 so as to allow the pressure oil to flow therethrough, and a switching mechanism 70 provided at a substantially central portion of the supply passage 62 for changing the supply of pressure oil between the first and second passages 66, 68. The supply passage 62 communicates with the outside via a second supply port 72 formed on a side surface of the end block 38.

As shown in FIG. 3, the first and second holes 58, 60 are formed with elongate hole configurations, each of which is curved at a predetermined radius. The first and second holes 58, 60 are formed respectively at symmetrical positions relative to the center of the rotary shaft 44. The first and second holes 58, 60 are provided at positions opposed to pump pistons 74 of the suction/discharge section 14. Pressure oil, which is discharged or sucked by the pump pistons 74, flows through the first and second holes 58, 60.

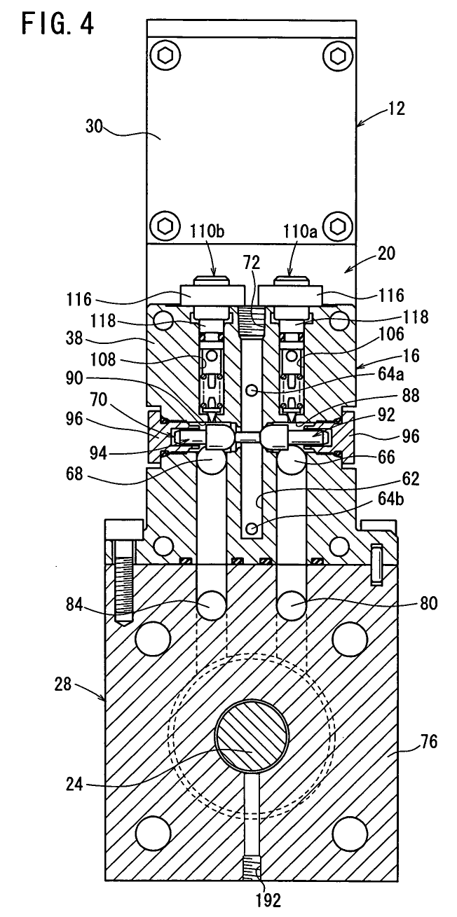

The first passage 66 that communicates with the first hole 58 and the second passage 68 that communicates with the second hole 60 extend predetermined lengths in a direction away from the pressure oil-charging chamber 40 respectively, and are bent substantially perpendicularly toward the cylinder mechanism 28 (see FIG. 2). The first and second passages 66, 68, which extend toward the cylinder mechanism 28, are formed substantially in parallel to one another while being separated by a predetermined distance with respect to the center of the supply passage 62 (see FIG. 4).

As described later, the first passage 66 communicates with a first cylinder chamber (chamber) 82 via the first cylinder passage 80 formed in a cylinder tube 78 and a first cover member 76 of the cylinder mechanism 28. Further, the second passage 68 communicates with a second cylinder chamber (chamber) 86 via the second cylinder passage 84 formed in the cylinder tube 78 and the first cover member 76.

Concerning the communication passages 64a, 64b, one communication passage 64a is connected on a side proximate to the driving section 12, with the switching mechanism 70 in the supply passage 62 as a boundary, and the other communication passage 64b is connected on a side proximate to the cylinder mechanism 28 of the supply passage 62, with the switching mechanism 70 as a boundary.

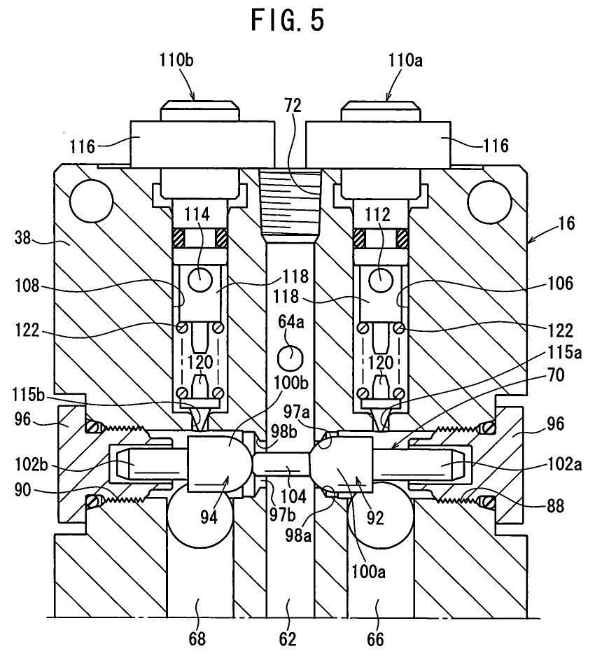

As shown in FIGS. 4 and 5, the switching mechanism 70 comprises a pair of first and second installation holes (connecting passages) 88, 90 provided substantially perpendicularly to the axis of the supply passage 62, a pair of first and second valves (selector valves) 92, 94 which are displaceable respectively along the first and second installation holes 88, 90, and a pair of plugs 96 closing respective open ends of the first and second installation holes 88, 90.

The first and second installation holes 88, 90 extend mutually in opposition to each other from respective side surfaces of the end block 38 while extending toward the supply passage 62. The first and second installation holes 88, 90 communicate with the supply passage 62 via respective communication holes 97a, 97b. The communication holes 97a, 97b are formed with diameters that are reduced radially inwardly with respect to the first and second installation holes 88, 90.

The first and second installation holes 88, 90 are formed to have tapered shapes, so that diameters thereof are gradually reduced toward the communication holes 97a, 97b. The tapered first and second installation holes 88, 90 have inner wall surfaces 98a, 98b that serve as seating surfaces for seating the first and second valves 92, 94 thereon.

The first installation hole 88 communicates with the first passage 66 at a substantially central portion thereof, and the second installation hole 90 communicates with the second passage 68 at a substantially central portion thereof.

The first valve 92 includes a valve head 100a arranged in the first installation hole 88 and having a spherical surface, and a valve shaft 102a connected to the valve head 100a and inserted into the plug 96 that seals the first installation hole 88. The first valve 92 is arranged so that the valve head 100a thereof is disposed alongside the communication hole 97a. A shaft-shaped pin 104, which is formed on the valve head 100a, is inserted into the supply passage 62 via the communication hole 97a.

The second valve 94 includes a valve head 100b arranged in the second installation hole 90 and having a spherical surface, and a valve shaft 102b connected to the valve head 100b and inserted into the plug 96 that seals the second installation hole 90. The valve head 100b is arranged so as to oppose the valve head 100a of the first valve 92. The pin 104 formed on the valve head 100a abuts against the valve head 100b of the second valve 94.

More specifically, when pressure oil is caused to flow into the first and second installation holes 88, 90 via the first and second passages 66, 68, the first and second valves 92, 94 are displaced in an axial direction as a result of the pressing force exerted by the pressure oil. In particular, the first and second valves 92, 94 are displaced in an axial direction, from a side having large pressure toward a side having small pressure, by an amount corresponding to a differential pressure between pressures of the pressure oil introduced into the first installation hole 88 and the pressure oil introduced into the second installation hole 90.

First and second adjusting chambers 106, 108 are formed at positions opposed respectively to the first and second passages 66, 68 in the first and second installation holes 88, 90. A pair of relief valves (valve plugs) 110a, 100b are arranged in the first and second adjusting chambers 106, 108. The first and second adjusting chambers 106, 108 are formed substantially in parallel to one another, such that the first and second adjusting chambers 106, 108 are separated from each other by a predetermined distance with respect to a center of the supply passage 62. First and second return passages 112, 114 (described later on) are connected respectively at substantially central portions thereof. More specifically, the first and second adjusting chambers 106, 108 are substantially perpendicular to the first and second installation holes 88, 90, and are formed along substantially straight lines together with the first and second passages 66, 68 respectively.

First and second return passages 112, 114, which extend substantially linearly toward the pressure oil-charging chamber 40, are formed in the end block 38 (see FIG. 2). The first and second return passages 112, 114 are separated from each other by a predetermined distance and are formed between the pressure oil-charging chamber 40 and the first and second adjusting chambers 106, 108.

A connecting passage 115a is formed between the first adjusting chamber 106 and the first installation hole 88. Further, a connecting passage 115b is formed between the second adjusting chamber 108 and the second installation hole 90. That is, the first adjusting chamber 106 and the first installation hole 88 communicate with each other via the connecting passage 115a, and the second adjusting chamber 108 and the second installation hole 90 communicate with each other via the connecting passage 115b. The connecting passages 115a, 115b are formed with diameters that are reduced radially inwardly with respect to the first and second adjusting chambers 106, 108.

Each of the relief valves 110a, 110b comprises a main body section 118, which is inserted into each of the first and second adjusting chambers 106, 108 from an open side surface of the end block 38 and which is fixed by a nut 116 engaged with a step section thereof, a valve section 120 separated a predetermined distance from the end of the main body section 118, and a spring 122 interposed between the main body section 118 and the valve section 120.

The valve sections 120 are continuously urged in directions away from the main body sections 118, by means of resilient forces of the springs 122. The valve sections 120 abut against openings of the connecting passages 115a, 115b respectively under a resilient action of the springs 122. Accordingly, communication between the first and second adjusting chambers 106, 108 and the first and second installation holes 88, 90 is blocked.

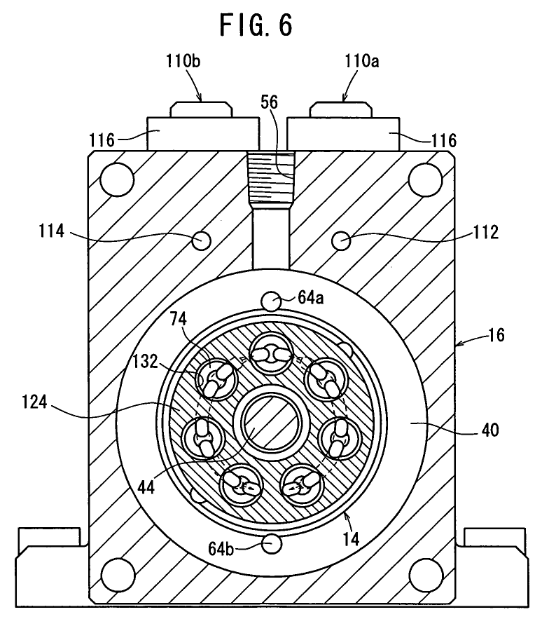

As shown in FIGS. 2 and 6, a suction/discharge section 14 is provided in the pump mechanism 16. The suction/discharge section 14 includes a cylinder block 124 connected through a spline to a central portion of the rotary shaft 44, wherein the cylinder block 124 is rotatable integrally with the rotary shaft 44, and a plurality of holes 126 separated from each other by predetermined angles in a circumferential direction of the cylinder block 124. The suction/discharge section 14 further includes a plurality of pump pistons 74, which are provided substantially in parallel to the axis of the rotary shaft 44 and which make sliding movements along the holes 126 of the cylinder block 124, and pressure oil holes 128 formed through the cylinder block 124 on the side of the end block 38 (in the direction of the arrow B as shown in FIG. 2) which communicate with the holes 126.

Each of the pump pistons 74 comprises a spherical section 130 having a substantially spherical shape formed on one end thereof, and a recess 132 formed in the other end thereof, which is recessed toward the one end. A spring 134 is interposed between the recess 132 and the hole 126 of the cylinder block 124. The pump piston 74 is pressed continuously toward the coupling section 18 (in the direction of the arrow A) by means of the resilient force of the spring 134. A chamber 136 is formed by the hole 126 and the recess 132, wherein the chamber 136 functions both as a pressure oil-sucking chamber and a pressure oil-discharging chamber.

The suction/discharge section 14 further includes a tiltable member 140, which remains out of contact with the rotary shaft 44 by means of a through-hole 138, and which is tiltable by a predetermined angle with respect to the axis of the rotary shaft 44.

The tiltable member 140 is substantially disk-shaped. A pressing member 144, installed displaceably within a recess 142 of the pump body 36, abuts against the tiltable member 140. The pressing member 144 is pressed continuously toward the tiltable member 140 (in the direction of the arrow B) by means of a spring 146 interposed between the pressing member 144 and the recess 142.

The pump body 36 is provided with a stopper 148 disposed at a symmetrical position with respect to the pressing member 144 about the center of the rotary shaft 44. The stopper 148 protrudes toward the tiltable member 140 (in the direction of the arrow B). The tiltable member 140 is tilted by being pressed by the pressing member 144 in a direction separating away from the pump body 36 (in the direction of the arrow B). The tilting operation of the tiltable member 140 is regulated by abutment of the tiltable member 140 against the stopper 148.

That is, the angle of inclination of the tiltable member 140 is automatically changed depending on pressure fluctuations in the pressure oil-charging chamber 40, thus making it possible to change the discharge amount of the pressure oil by the pump pistons 74.

In other words, when the tiltable member 140 is substantially in parallel to the end surface of the pump body 36, the discharge amount of pressure oil brought about by the pump mechanism 16 is decreased, and therefore, the piston 22 of the cylinder mechanism 28, which is driven by a pressing force exerted by the pressure oil, is displaced at a low speed. On the other hand, as the angle of the tiltable member 140 with respect to the end surface of the pump body 36 increases, the discharge amount of pressure oil brought about by the pump mechanism 16 also increases, whereby the piston 22 is displaced at a high speed by the pressure oil.

As shown in FIG. 1, the power transmission mechanism 20 is provided with a base member 150, which interconnects the driving section 12 and the pump mechanism 16. The power transmission mechanism 20 includes a box-shaped cover member 152 installed on the base member 150, a first pulley 34 provided in the cover member 152 and installed on the drive shaft 32 of the rotary driving source 30, a second pulley 154 that transmits a driving force from the first pulley 34 via the coupling section 18 to the pump mechanism 16, and a transmission belt 156 that runs over and between the first pulley 34 and the second pulley 154.

The second pulley 154 is installed on a pulley shaft 160 which is rotatably supported by a pair of bearings 158 provided in the base member 150 and the cover member 152 respectively. The second pulley 154 rotates integrally with the pulley shaft 160.

The pulley shaft 160 is connected to the rotary shaft 44 of the pump mechanism 16, via a coupling member 162 of the coupling section 18.

Accordingly, a driving force output from the driving section 12 is transmitted from the first pulley 34 via the transmission belt 156 to the second pulley 154, so as to rotate the second pulley 154. Accordingly, the driving force is transmitted to the rotary shaft 44, whereby the pump mechanism 16 is driven and rotated.

The coupling section 18 includes a hollow coupling casing 164, which is provided between the pump body 36 of the pump mechanism 16 and the base member 150 of the power transmission mechanism 20, and the coupling member 162, which is arranged inside the coupling casing 164 for connecting the pulley shaft 160 and the rotary shaft 44.

The cylinder mechanism 28 includes the cylindrical cylinder tube 78, and first and second cover members 76, 168 that close respective ends of the cylinder tube 78. Included within the cylinder tube 78 are the piston 22, which is displaceable in the axial direction, and first and second piston rods 24, 26 connected coaxially to the piston 22, with the piston 22 intervening therebetween. The cylinder mechanism 28 is disposed substantially in parallel to the driving section 12 and the pump mechanism 16.

A pair of first and second ports 170, 172 communicating with the first and second cylinder chambers 82, 86 are formed on a side surface of the cylinder tube 78. Unillustrated detecting devices (for example, pressure sensors) are installed in the first and second ports 170, 172. Pressures within the first and second cylinder chambers 82, 86 are detected by such detecting devices. When detecting sections are not installed therein, the first and second ports 170, 172 are closed by plugs 174. Accordingly, liquid tightness of the first and second cylinder chambers 82, 86 can be retained.

The first cover member 76 is disposed on one end of the cylinder tube 78 on the side of one end surface of the piston 22. The first cylinder chamber 82 is formed in the cylinder tube 78 between the first cover member 76 and one end surface of the piston 22. A first cylinder passage 80, which is opposed to the first passage 66 of the end block 38 of the pump mechanism 16, is formed in the first cover member 76. The first cylinder passage 80 extends substantially perpendicularly toward the cylinder tube 78, communicating with the first cylinder chamber 82.

On the other hand, the second cover member 168 is arranged on the other end of the cylinder tube 78, on the side of another end surface of the piston 22. The second cylinder chamber 86 is formed in the cylinder tube 78 between the second cover member 168 and the other end surface of the piston 22. A second cylinder passage 84, which is opposed to the second passage 68 of the end block 38, is formed in the second cover member 168. The second cylinder passage 84 extends substantially perpendicularly toward the cylinder tube 78, communicating with the second cylinder chamber 86.

That is, the first cylinder chamber 82 communicates with the first passage 66 of the pump mechanism 16 via the first cylinder passage 80. Pressure oil stored in the pressure oil-charging chamber 40 is supplied/discharged via the first passage 66 and the first cylinder passage 80. Similarly, the second cylinder chamber 86 communicates with the second passage 68 of the pump mechanism 16 via the second cylinder passage 84. Pressure oil stored in the pressure oil-charging chamber 40 is supplied/discharged via the second passage 68 and the second cylinder passage 84.

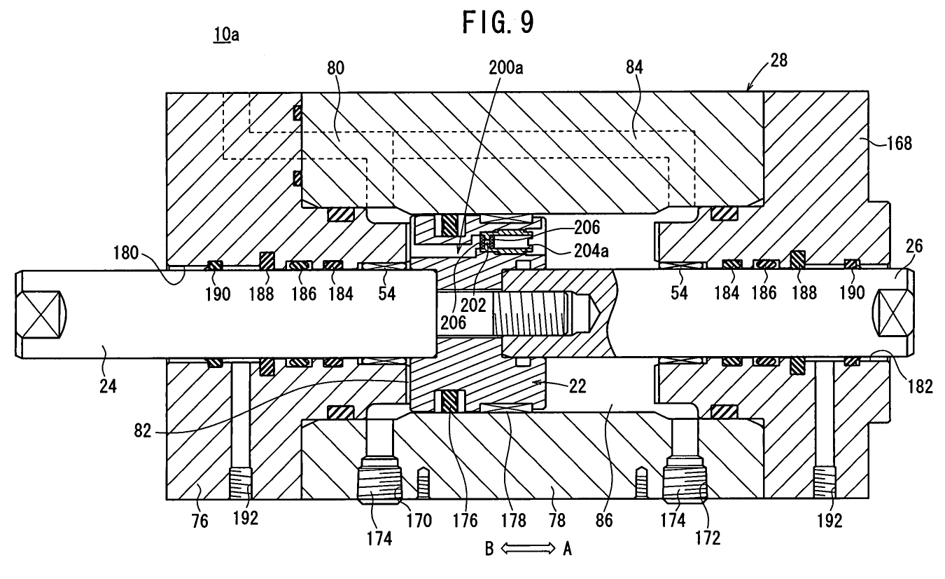

A piston packing 176 is provided in an annular groove on the outer circumferential surface of the piston 22. Further, an annular wear ring 178 is separated a predetermined distance from the piston packing 176 (see FIG. 9). Liquid tightness is retained for the first cylinder chamber 82 and the second cylinder chamber 86 as a result of the piston packing 176 and the wear ring 178 respectively. The piston 22 is displaceable in the axial direction under an action of pressure oil supplied to the first cylinder chamber 82 and the second cylinder chamber 86.

One end of an elongate first piston rod 24 is inserted through the first cover member 76 into a substantially central portion of the piston 22, and one end of an elongate second piston rod 26 is inserted through the second cover member 168 into a substantially central portion of the piston 22. The first piston rod 24 and the second piston rod 26 are threadedly engaged in the piston 22 respectively. The other end of the first piston rod 24 is supported for displacement in the axial direction in a first support hole 180 of the first cover member 76. The other end of the second piston rod 26 is supported for displacement in the axial direction in a second support hole 182 of the second cover member 168.

A plurality of annular grooves, separated from each other by predetermined distances, are formed in each of the first and second support holes 180, 182. Bushes 54, rod packings 184, O-rings 186, lubricating oil-retaining members 188, and dust-removing members 190 are installed in order within the annular grooves (see FIG. 9). Supplement ports 192, which communicate between the outside of the first and second cover members 76, 168 and the first and second support holes 180, 182, are formed in the first and second cover members 76, 168 respectively. Lubricating oil is charged via the supplement ports 192, and thus lubrication may be maintained between the first and second support holes 180, 182 and the first and second piston rods 24, 26.

Accordingly, the piston 22 is displaced in the axial direction under a pressing action effected by pressure oil introduced into the first and second cylinder chambers 82, 86, and the first and second piston rods 24, 26 are displaced integrally together with the piston 22.

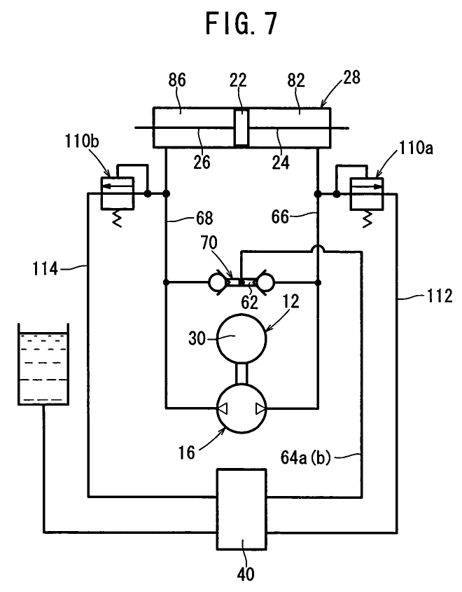

The actuator 10 according to the first embodiment of the present invention is basically constructed as described above. Next, its operation, functions and effects shall be explained. It is assumed that the actuator 10 is in a state in which pressure oil is charged into the pressure oil-charging chamber 40 from an unillustrated pressure oil supply source via the first supply port 56. FIG. 7 shows a schematic circuit diagram illustrating a closed circuit formed by the actuator and through which the pressure oil flows.

An unillustrated power source is energized to drive and rotate the rotary driving source 30 of the driving section 12 through a control unit. The drive shaft 32 is rotated under a driving action of the rotary driving source 30, whereby a driving force is transmitted to the rotary shaft 44 of the pump mechanism 16 via the power transmission mechanism 20.

The cylinder block 124, which is joined to the rotary shaft 44, is rotated in an integrated manner, and the pump pistons 74 disposed in the cylinder block 124 are rotated about the center of the rotary shaft 44. The pump pistons 74 are displaced in axial directions (in the directions of the arrows A and B) in accordance with resilient forces of the springs 134, while the spherical sections 130 of the pump pistons 74 are retained inside the annular groove of the tiltable member 140.

Accordingly, when the pump pistons 74 are displaced to their bottom dead center position disposed most closely to the end block 38 (in the direction of the arrow B) under a pressing action of the tiltable member 140, pressure oil, which has been charged into the chambers 136, is discharged by the pump pistons 74 into the first passage 66 via the first hole 58.

Conversely, when the pump pistons 74 are displaced to their top dead center position disposed most closely to the coupling section 18 (in the direction of the arrow A) under the resilient force of the springs 134, pressure oil is sucked into the chambers 136 via the second hole 60 due to the displacement of the pump pistons 74.

In particular, when the pump pistons 74 are displaced to a position opposed to the first passage 66 of the end block 38, the pump pistons 74 are displaced to their bottom dead center position disposed most closely to the end block 38 (in the direction of the arrow B) under a pressing action effected by the tiltable member 140. Thus, pressure oil, which has been charged into the chambers 136, is discharged through the pressure oil holes 128. On the other hand, when the pump pistons 74 are displaced to a position opposed to the second passage 68, the pump pistons 74 are displaced to their top dead center position disposed most closely to the coupling section 18 (in the direction of the arrow A), and pressure oil is sucked into the chambers 136 via the pressure oil holes 128.

That is, the pump pistons 74 are rotated about the center of the rotary shaft 44, while repeatedly sucking and discharging pressure oil in and out of the inside of the chambers 136, as a result of repeated displacement of the pump pistons 74 in the axial direction (in the directions of the arrows A and B) under a rotary action of the rotary shaft 44.

Pressure oil, which is discharged by the pump pistons 74, is led out to the first cylinder passage 80 of the cylinder mechanism 28 via the first passage 66 of the end block 38, and the pressure oil is supplied into the first cylinder chamber 82. The piston 22 is pressed toward the second cover member 168 (in the direction of the arrow A) due to the pressure oil supplied into the first cylinder chamber 82. Accordingly, the first and second piston rods 24, 26 are displaced integrally in the direction of the arrow A.

During this process, pressure oil remaining in the second cylinder chamber 86 of the cylinder mechanism 28 is discharged from the second cylinder chamber 86 to the pressure oil-charging chamber 40 via the second passage 68 under a displacement action of the pump pistons 74.

On the other hand, when the piston 22 and the first and second piston rods 24, 26 of the cylinder mechanism 28 are displaced toward the first cover member 76 (in the direction of the arrow B), conversely to the above, polarity of the current supplied to the rotary driving source 30 is reversed. Accordingly, the rotary shaft 44 connected to the power transmission mechanism 20, is rotated in an integrated manner in an opposite direction, through operation of the drive shaft 32 of the rotary driving source 30, the power transmission mechanism 20, and the coupling section 18. Accordingly, the cylinder block 124 of the pump mechanism 16 is rotated in an opposite direction by means of the rotary shaft 44. Pressure oil, which has been introduced into the first cylinder chamber 82, is discharged via the first cylinder passage 80 and the first passage 66, and the pressure oil is returned to the pressure oil-charging chamber 40. Simultaneously, pressure oil is discharged into the second passage 68 of the end block 38 under a displacement action of the pump pistons 74, whereby the pressure oil is supplied to the second cylinder chamber 86 via the second cylinder passage 84 of the cylinder tube 78.

As a result, the pressure in the second cylinder chamber 86 is raised. The piston 22 of the cylinder mechanism 28 is displaced toward the first cover member 76 (in the direction of the arrow B) under a pressing action of the pressure oil supplied into the second cylinder chamber 86. Further, the first and second piston rods 24, 26 are displaced in the direction of the arrow B in an integrated manner in accordance with the displacement of the piston 22.

Next, an explanation will be given concerning the actuator 10 described above, in which a pressing abutment operation is performed on a workpiece (not shown) by means of a displacement force of the first and second piston rods 24, 26 making up the cylinder mechanism 28. In the pressing abutment operation, the first or second piston rod 24, 26 abuts against the workpiece, displacement thereof is regulated, and operation of the first or second piston rod 24, 26 is subsequently halted. In this case, it shall be assumed that the piston 22 is displaced toward the second cover member 168 (in the direction of the arrow A) by pressure oil introduced into the first cylinder chamber 82.

The rotary driving source 30 is rotated at a substantially constant rotational speed, whereby the pump mechanism 16 is also caused to rotate at a substantially constant speed. Accordingly, a predetermined amount of pressure oil is constantly supplied to the first cylinder chamber 82 by the pump pistons 74.

In this situation, the first valve 92 of the switching mechanism 70 is seated on the inner wall surface 98a of the first installation hole 88 under a pressing action effected by the pressure oil, which is caused to flow into the first installation hole 88 from the first passage 66. Therefore, communication between the first installation hole 88 and the supply passage 62 is blocked. Conversely, the second valve 94 is pressed by the pin 104 of the first valve 92. Therefore, the second valve 94 separates from the inner wall surface 98b of the second installation hole 90, providing a state in which the second installation hole 90 and the supply passage 62 are placed in communication with each other.

Accordingly, pressure oil discharged from the pump mechanism 16 is not allowed to flow from the first passage 66 into the supply passage 62 via the first installation hole 88, while the pressure oil is supplied into the first cylinder chamber 82. On the other hand, pressure oil in the second cylinder chamber 86 is allowed to flow from the second cylinder passage 84 into the second passage 68 under a sucking action of the pump mechanism 16, wherein the pressure oil is allowed to flow into the supply passage 62 via the second installation hole 90 as a result of the second valve 94 being open, and the pressure oil is discharged to the pressure oil-charging chamber 40.

Pressure oil is continuously supplied from the pump mechanism 16 to the first cylinder chamber 82, and therefore the pressure of the pressure oil in the first cylinder chamber 82 is gradually raised. In this situation, the pressure of the pressure oil is also raised within the first cylinder passage 80, the first passage 66, and the first installation hole 88, which are in communication with the first cylinder chamber 82.

Accordingly, the valve section 120 of the relief valve 110a provided in the first adjusting chamber 106 is displaced toward the main body section 118 against a resilient force of the spring 122, as a result of the pressure of the pressure oil in the first installation hole 88, and the valve section 120 separates from the connecting passage 115a. In other words, the pressure of the pressure oil in the first installation hole 88 is larger than the resilient force of the spring 122 of the relief valve 110a, and thus the valve section 120 separates from the connecting passage 115a.

Accordingly, pressure oil contained in the first passage 66 and the first installation hole 88 is introduced into the first adjusting chamber 106 via the connecting passage 115a. The pressure oil flows additionally from the first adjusting chamber 106 to the pressure oil-charging chamber 40 via the return passage 112. That is, due to opening of the relief valve 110a , excessive pressure oil in the first cylinder chamber 82 is recirculated to the pressure oil-charging chamber 40 via the return passage 112. In other words, the relief valve 110a releases into the pressure oil-charging chamber 40 a portion of the pressure oil flowing from the first passage 66 to the first cylinder chamber 82.

As the pressure of the first cylinder chamber 82 is gradually lowered, and the pressure is at or below a predetermined value, then the resilient force of the spring 122 of the relief valve 110a overcomes the pressure of the pressure oil, and the valve section 120 is seated on the connecting passage 115a to close the connecting passage 115a. Accordingly, communication between the first installation hole 88 and the first adjusting chamber 106 is blocked, thereby halting the flow of pressure oil into the pressure oil-charging chamber 40 via the first installation hole 88 and the return passage 112. Also, in this situation, pressure oil is continuously supplied from the pump mechanism 16 into the first cylinder chamber 82. Therefore, the pressure in the first cylinder chamber 82 is maintained at a substantially constant value.

The foregoing explanation concerns a case in which pressure oil is supplied to the first cylinder chamber 82 via the first passage 66. When pressure oil is supplied from the pump mechanism 16 to the second cylinder chamber 86 via the second passage 68, a portion of the pressure oil is recirculated to the pressure oil-charging chamber 40 by the relief valve 110b via the second return passage 114.

As described above, the first embodiment is constructed such that pressure oil is supplied from the pump mechanism 16 via the first or second passage 66, 68 to the cylinder mechanism 28, and the piston 22 of the cylinder mechanism 28 is displaced in an axial direction. For example, when it is intended to retain a workpiece utilizing a displacement force of the piston 22, a portion of the pressure oil supplied to the cylinder mechanism 28 from the first or second passage 66, 68 is recirculated to the pressure oil-charging chamber 40 via the first or second return passages 112, 114, under an opening/closing operation of the relief valves 110a, 110b provided in the pump mechanism 16.

Accordingly, the pressure of the pressure oil in the cylinder mechanism 28 is gradually lowered. Therefore, the pressure oil is constantly supplied by the pump mechanism 16 under a driving action of the driving section 12, in order to maintain a constant pressure value of the pressure oil. As described above, the pressure oil is recirculated to the pressure oil-charging chamber 40 so that the pressure of pressure oil in the cylinder mechanism 28 is gradually lowered in slight amounts. Accordingly, it is possible to affect a control in which the driving section 12 is constantly driven and rotated, in order to supplement a decrease in the pressure of the pressure oil.

As a result, the displacement force (thrust force) of the piston 22 is maintained substantially constant in the cylinder mechanism 28. Accordingly, the workpiece can be reliably and strongly retained by the cylinder mechanism 28. For example, when a pressing abutment operation is performed by the actuator 10 in order to retain a workpiece, the driving section 12 can be driven and rotated at a low rotational speed having a low number of revolutions (for example, 300 to 500 rpm), as compared with a conventional actuator. Further, a substantially equivalent thrust force can be obtained. Therefore, in the actuator 10, energy can be transmitted more efficiently from the driving section 12 to the cylinder mechanism 28. That is, even when the current supplied to the driving section 12 decreases, a thrust force can be obtained which is substantially equivalent to the thrust force formerly obtained in conventional devices. Therefore, it is possible to realize an energy savings when using the actuator 10.

The pump mechanism 16, the cylinder mechanism 28 to which pressure oil is supplied from the pump mechanism 16, the switching mechanism 70, and the relief valves 110a, 110b are connected in a closed circuit together with the first and second passages 66, 68, the supply passage 62, the first and second return passages 112, 114, and the pressure oil-charging chamber 40, whereas the driving section 12, to which the electric signal is applied, is formed as an open circuit.

Accordingly, when the pressure of the pressure oil is lowered in the cylinder mechanism 28, a feedback control is not required to drive the driving section 12 on the basis of a pressure value of the pressure oil. The driving section 12 can be controlled on the basis of a decrease in pressure of the pressure oil, whereby the pressure can be restored to a substantially constant state, simply by recirculating the pressure oil to the pressure oil-charging chamber 40 from the first or second passages 66, 68, by operation of the relief valves 110a, 110b. Accordingly, the pressure of the pressure oil can be maintained substantially constant, and driving can be stably performed using a simple arrangement, in which the driving section 12 is provided as an open electrical circuit, and wherein other constitutive components including the relief valves 110a, 110b are connected in a closed circuit.

In other words, the actuator 10 includes the driving section 12, which is composed of, for example, an AC servo motor, the pump mechanism 16 which exhibits only slight pressure oil leakage, and the relief valves 110a, 110b which recirculate to the pressure oil-charging chamber 40 a portion of the pressure oil supplied to the cylinder mechanism 28, and wherein electrically an open circuit control is performed. Accordingly, the cylinder mechanism 28 can be driven efficiently by supplying pressure oil thereto.

In the case of the actuator 10, the flow rate of pressure oil supplied from the pump mechanism 16 to the cylinder mechanism 28 can be freely controlled by adjusting the rotational speed of the rotary driving source 30 and the angle of inclination of the tiltable member 140 of the pump mechanism 16. Therefore, in the actuator 10, when a displacement speed of the cylinder mechanism 28 is required, the amount of pressure oil supplied by the pump mechanism 16 is increased. Conversely, when an output torque in the cylinder mechanism 28 is required, the pump mechanism 16 is rotated at a low speed in order to decrease the amount of pressure oil supplied to the cylinder mechanism 28.

Pressure oil used to drive the cylinder mechanism 28 is allowed to flow through the first and second passages 66, 68, the first and second cylinder passages 80, 84, the supply passage 62, and the first and second return passages 112, 114 connected between the pump mechanism 16 and the cylinder mechanism 28. When pressure oil flow passages are formed in the actuator 10 as described above, it is possible to avoid, for example, leakage of pressure oil, complicated piping connections, an increased size of the actuator due to such piping connections, and an increase in cost of the apparatus, as compared with a case in which the piping connections through which the pressure oil flows are connected outside the actuator 10.

The pressure oil used for the actuator 10 is preferably a silicone oil. Silicone oil exhibits characteristics of predetermined compressibility, owing to its smaller modulus of elasticity of volume, as compared with mineral oil, and further, temperature dependent changes in viscosity thereof are small. Therefore, even when sudden pressure fluctuations occur in the pressure oil, such pressure fluctuations can be attenuated, and it is possible to obtain a stable output from the actuator 10. Further, silicone oil generally has chemically inert or inactive characteristics. Therefore, the handling performance thereof is more satisfactory as compared with mineral oil.

More preferably, dimethylsilicone should be used as the silicone oil. Dimethylsilicone exhibits excellent characteristics of resistance to both heat and cold. When using dimethylsilicone, there is a concern that lubrication performance could be lowered when the elements making up the pump mechanism 16 undergo sliding displacement while being pressed in contact with each other. However, in this case, lubrication performance can be improved by using an additive (for example, hydrocarbon).

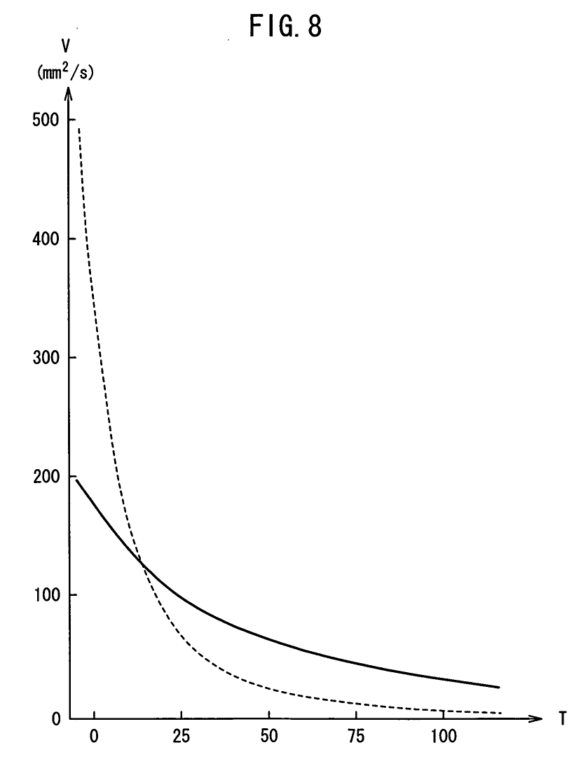

Next, a brief explanation shall be made with reference to FIG. 8 concerning temperature-dependent changes in viscosity with respect to changes in the temperature of the pressure oil in the pump mechanism 16. The curve depicted by the solid line in FIG. 8 indicates a characteristic obtained when dimethylsilicone was used as pressure oil in the pump mechanism 16. The curve depicted by the broken line indicates a characteristic obtained when general mineral oil was used as the pressure oil.

In general, the temperature range when using an axial pump applied to the pump mechanism 16 is set at about 5° C. to 60° C. For example, the following facts are clearly understood when mineral oil, having a characteristic kinematic viscosity V of 32 mm²/s at 40° C., and dimethylsilicone, having a characteristic kinematic viscosity V of 100 mm²/s at 25° C., are respectively applied to the pump mechanism 16 and compared. More specifically, when the temperature is changed within a range of about −5° C. to 100° C., the kinematic viscosity V of mineral oil changes within a range of about 30 to 500 mm²/s, whereas the kinematic viscosity V of dimethylsilicone changes within a range of about 20 to 200 mm²/s.

When dimethylsilicone, which exhibits excellent resistance to both heat and cold, is applied as the pressure oil as described above, the viscosity change of the pressure oil with respect to changes in temperature can be suppressed. Therefore, the pump mechanism 16 can be used within a wide temperature region, ranging from low temperatures to high temperatures, in the environment in which the pump mechanism 16 is used. As a result, workpieces can be stably retained for longer periods of time when driving of the actuator 10 is stopped in a workpiece-retaining state.

Next, actuators 10a to 10e according to first to fifth modified embodiments, as shown in FIGS. 9 to 13, shall be explained. The same constitutive components as those of the actuator 10 according to the first embodiment described above shall be designated using the same reference numerals and detailed explanation of such components shall be omitted.

The actuators 10a to 10e according to the first to fifth modified embodiments are provided with bypass passages 200a to 200c therein, which enable communications between the first passage 66 and the second passage 68, or between the first cylinder passage 80 that connects to the first cylinder chamber 82 and second cylinder passage 84 that connects to the second cylinder chamber 86, respectively.

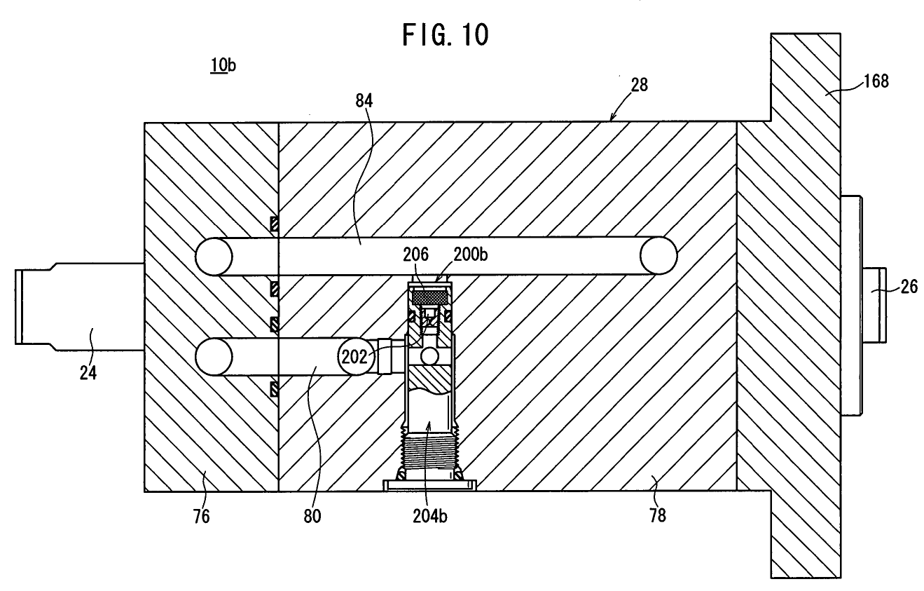

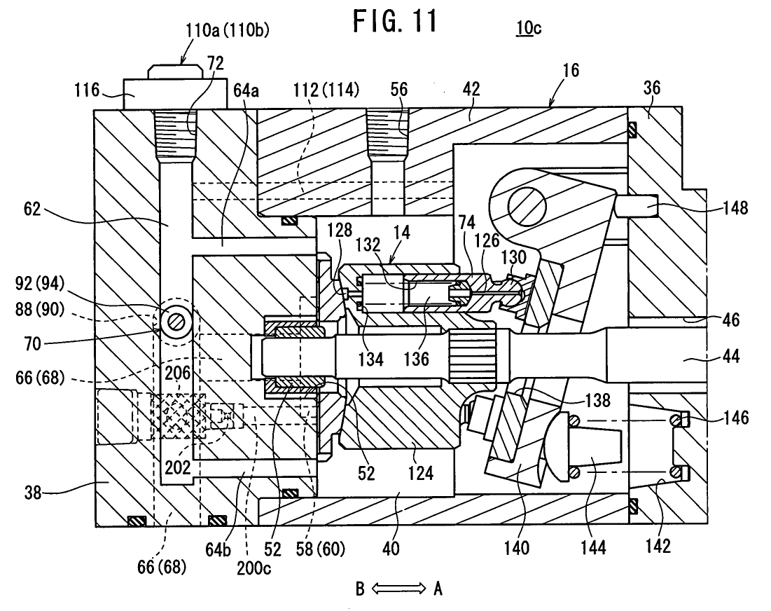

The bypass passage 200a to 200c may be formed in the piston 22 to provide communication between the first cylinder passage 82 and the second cylinder passage 86 (see FIG. 9), or may be formed in the cylinder tube 78 to provide communication between the first cylinder passage 80 and the second cylinder passage 84 (see FIG. 10), or alternatively, may be formed in tandem in the end block 38 of the pump mechanism 16, so as to provide communication between the first and second passages 66, 68 and the pressure oil-charging chamber 40 respectively (see FIG. 11). In each of the actuators 10a to 10e according to the first to fifth embodiments, the bypass passage 200a to 200c is formed at only one of the functional points described above, and the bypass passage 200a to 200c is not formed at a plurality of such functional points simultaneously.

At first, as shown in FIG. 9, in the actuator 10a according to the first modified embodiment, the bypass passage 200a is formed in the piston 22, while being separated by a predetermined distance radially outwardly within the piston 22 with respect to the first and second piston rods 24, 26. A throttle plug 204a, including a throttle section 202 having a reduced diameter as compared with the passage diameter (for example, 0.2 to 0.3 mm in diameter), is installed in the bypass passage 200a. A pair of filters 206 is installed in the throttle plug 204a sandwiching the throttle section 202 therebetween. Dust or the like, which may be contained in the pressure oil and flow into the throttle section 202 from the first and second cylinder chambers 82, 86, is removed by the filters 206. Accordingly, clogging of the throttle section 202, which has a small passage diameter, can be prevented. Alternatively, the filter 206 may be provided only on an upstream side (high pressure side) in relation to the flow of pressure oil with respect to a boundary of the throttle section 202.

The throttle section 202 may be a choke throttle, in which the passage diameter is reduced while also extending a predetermined length in the axial direction. Alternatively, the throttle section 202 may be, for example, a temperature compensation type throttle, such as a plate-shaped thin blade orifice. Accordingly, when the throttle section 202 is a choke throttle, because the choke throttle has a predetermined length in the axial direction, the flow rate of the pressure oil can be changed depending on a viscous resistance thereof obtained when the pressure oil flows therethrough. When the throttle section 202 is an orifice, the flow rate can be changed by rapidly changing the cross-sectional area of the flow passage through which the pressure oil flows.

In the actuator 10a constructed as described above, when the piston 22 is displaced toward the second cover member 168 (in the direction of the arrow A), the pressure oil contained in the second cylinder chamber 86 flows toward the first cylinder chamber 82 via the bypass passage 200a. In this situation, the flow rate of the pressure oil is throttled a predetermined amount by the throttle section 202 provided in the bypass passage 200a. Therefore, the flow rate of the pressure oil that flows from the second cylinder chamber 86 to the first cylinder chamber 82 is restricted. The pressure oil is discharged in minute amounts to the pressure oil-charging chamber 40 via the first cylinder chamber 82. Accordingly, the pressure within the second cylinder chamber 86 can be gradually lowered. The driving section 12 can be controlled so as to be constantly driven and rotated, in order to supplement the decrease in pressure of the pressure oil.

When the piston 22 is displaced toward the first cover member 76 (in the direction of the arrow B) and the pressure oil contained in the first cylinder chamber 82 flows toward the second cylinder chamber 86 via the bypass passage 200a, the flow rate of pressure oil contained in the first cylinder chamber 82 is throttled a predetermined amount by the throttle section 202, and the pressure oil discharged from the second cylinder chamber 86 to the pressure oil-charging chamber 40 can flow at a minute flow rate.

Next, as shown in FIG. 10, the actuator 10b according to the second modified embodiment is constructed such that the bypass passage 200b is formed in the cylinder tube 78 between the first cylinder passage 80 and the second cylinder passage 84, and a throttle plug 204b, having a throttle section 202 with a reduced passage diameter, is installed in the bypass passage 200b.

Accordingly, for example, when the piston 22 is displaced toward the second cover member 168, the pressure oil contained in the second cylinder chamber 86 flows from the second cylinder passage 84 into the first cylinder passage 80 via the bypass passage 200b. In this situation, the flow rate of the pressure oil is throttled a predetermined amount by the throttle section 202 disposed in the bypass passage 200b. Therefore, the flow rate of pressure oil flowing from the second cylinder passage 84 to the first cylinder passage 80 is restricted, and pressure oil is discharged from the first cylinder passage 80 in minute amounts to the pressure oil-charging chamber 40 via the first passage 66.

As a result, it is possible to gradually lower the pressure in the second cylinder chamber 86. The driving section 12 can be controlled so as to be contstantly driven and rotated, in order to supplement the decrease in pressure of the pressure oil.

When the piston 22 is displaced toward the first cover member 76 and pressure oil contained in the first cylinder chamber 82 flows from the first cylinder passage 80 to the bypass passage 200b, the flow rate of the pressure oil is throttled by the throttle section 202. Accordingly, the pressure oil can be discharged from the first cylinder chamber 82 into the pressure oil-charging chamber 40 at a minute flow rate.

Next, as shown in FIG. 11, the actuator 10c according to the third modified embodiment is constructed such that bypass passages 200c are formed between the pressure oil-charging chamber 40 and the first and second passages 66, 68 of the pump mechanism 16, respectively, wherein a throttle plug 204c having a throttle section 202 is installed in each of the bypass passages 200c.

Accordingly, for example, when the piston 22 is displaced toward the second cover member 168, the flow rate of the pressure oil contained in the second cylinder chamber 86 is throttled a predetermined amount by the throttle section 202 provided in the bypass passage 200c, and the pressure oil contained in the second cylinder chamber 86 flows into the pressure oil-charging chamber 40. Therefore, the flow rate of the pressure oil is restricted, and the pressure oil is discharged into the pressure oil-charging chamber 40 in minute amounts.

As a result, the pressure in the second cylinder chamber 86 can be gradually lowered. Therefore, the driving section 12 can be controlled so as to be constantly driven and rotated in order to supplement the decrease in the pressure of the pressure oil.

When the piston 22 is displaced toward the first cover member 76, the pressure oil contained in the first cylinder chamber 82 flows from the first passage 66 to the bypass passage 200c, and thus the flow rate thereof is throttled by the throttle section 202, wherein the pressure oil can be discharged from the first cylinder chamber 82 into the pressure oil-charging chamber 40 at a minute flow rate.

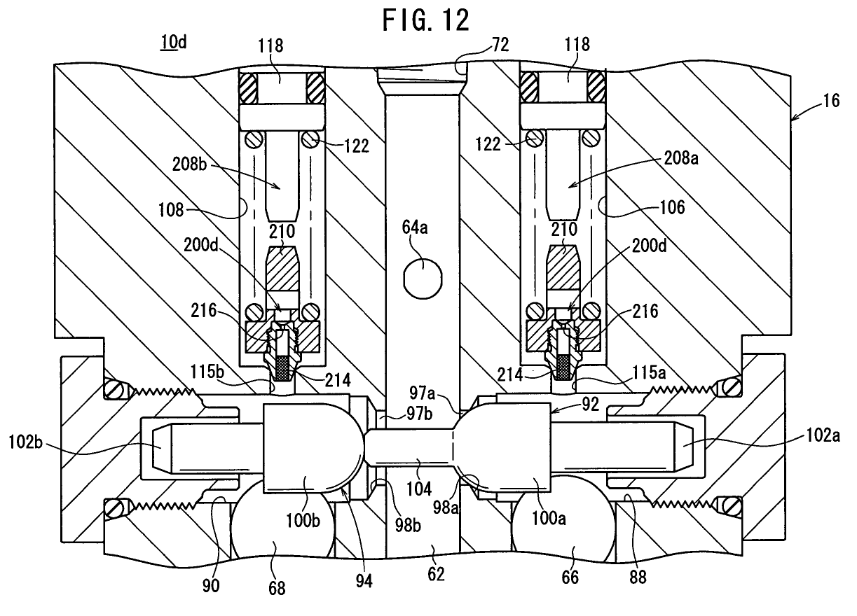

As shown in FIG. 12, the actuator 10d according to the fourth modified embodiment is constructed such that the bypass passages 200d are provided respectively in the pair of relief valves 208a, 208b. The valve section 210 making up each of the relief valves 208a, 208b contains a filter 214 disposed in the bypass passage 200d formed in a substantially central portion. Further, a throttle section 216 is providing, having a reduced diameter and communicating with the bypass passage 200d. The throttle section 216 communicates with the interior of each of the first and second adjusting chambers 106, 108 provided in the relief valves 208a, 208b.

Accordingly, when pressure oil is supplied to the first or second cylinder chamber 82, 86, the pressure oil flows to the first or second adjusting chamber 106, 108 via the bypass passages 200d and through the throttle sections 216 of the relief valves 208a, 208b, and further, the pressure oil flows into the pressure oil-charging chamber 40 via the communication passages 64a, 64b. In this situation, the flow rate of the pressure oil is throttled a predetermined amount by the throttle sections 216 in the bypass passages 200d. Therefore, the pressure oil flows from the first or second passage 66, 68 and into the pressure oil-charging chamber 40 at a restricted flow rate, wherein the pressure oil is discharged into the pressure oil-charging chamber 40 in minute amounts. As a result, the pressure of the first or second cylinder chamber 82, 86 can be gradually lowered. The driving section 12 can be controlled so as to be constantly driven and rotated, in order to supplement the decrease in pressure of the pressure oil.

On the other hand, when the pressure of the pressure oil that flows through the first or second passage 66, 68 is excessively large, then the valve sections 210 separate away from the connecting passages 115a, 115b as a result of the pressure of the pressure oil. Therefore, the pressure oil flows into the pressure oil-charging chamber 40 at a flow rate that is larger than the flow rate of pressure oil flowing through the throttle sections 216.

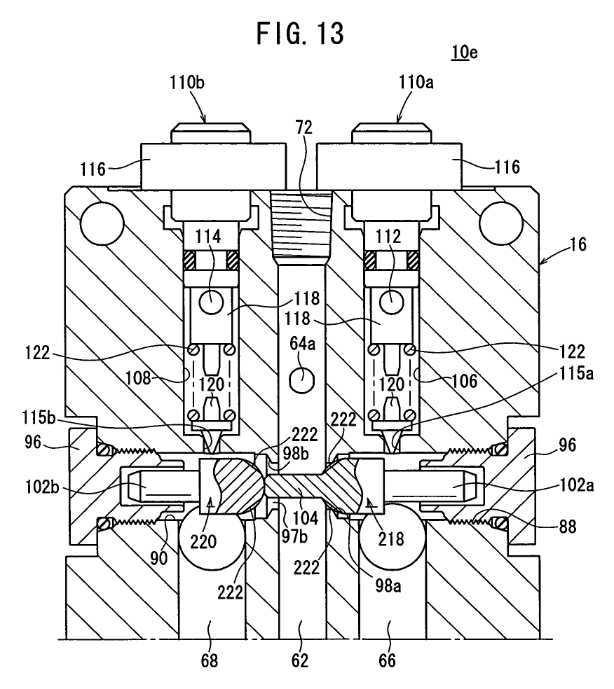

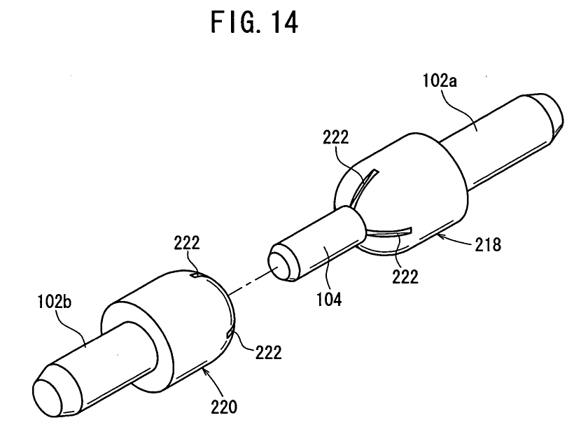

Further, as shown in FIG. 13, the actuator 10e according to the fifth modified embodiment is constructed to include a plurality of slits 222 (see FIG. 14), which are separated from each other by predetermined distances, provided on each of the valve heads 100a, 100b of the first and second valves 218, 220 of the switching mechanism 70. When the first or second valve 218, 220 is seated on the inner wall surface 98a, 98b of the first or second installation hole 88, 90, pressure oil flows gradually into the supply passage 62 via gaps between the slits 222 and the inner wall surface 98a, 98b. In other words, the slits 222 function as a throttle section, which regulates the flow rate of pressure oil flowing into the supply passage 62 via the first and second valves 218, 220.

Accordingly, owing to the slits 222 formed on the first and second valves 218, 220, pressure oil in the first and second passages 66, 68 can flow into the pressure oil-charging chamber 40 in minute amounts via the supply passage 62. Therefore, the pressure in the first or second cylinder chamber 82, 86 can be gradually reduced. The driving section 12 can be controlled so as to be constantly driven and rotated, in order to supplement the decrease in pressure of the pressure oil.

As described above, the actuators 10a to 10e are each provided with the flow rate throttle section, composed of one of a throttle section 216 formed in the bypass passage 200a to 200d or in the relief valve 208a, 208b, as described above, and slits 222 formed in the first and second valves 218, 220 of the switching mechanism 70. The flow rate throttle section is used to throttle the flow rate of pressure oil supplied to the first or second cylinder chamber 82, 86 of the cylinder mechanism 28 by a predetermined amount, so that a portion of the pressure oil is recirculated to the pressure oil-charging chamber 40.

As a result, recirculation is effected so that the pressure oil in the cylinder mechanism 28 is constantly returned in minute amounts to the pressure oil-charging chamber 40, whereby the pressure of pressure oil in the first or second cylinder chamber 82, 86 can be lowered in slight amounts. Therefore, the pressure of the pressure oil can be controlled to be substantially constant, by constantly driving and rotating the pump mechanism 16 at a low rotation, as compared to driving a conventional cylinder mechanism 28.

Concerning the bypass passages 200a to 200d, the throttle sections 216 formed in the relief valves 208a, 208b, and the slits 222 formed in the first and second valves 218, 220 of the switching mechanism 70, plural types of such features are not simultaneously provided in each of the actuators 10a to 10e, but rather, only one type is provided in each of the actuators 10a to 10e.

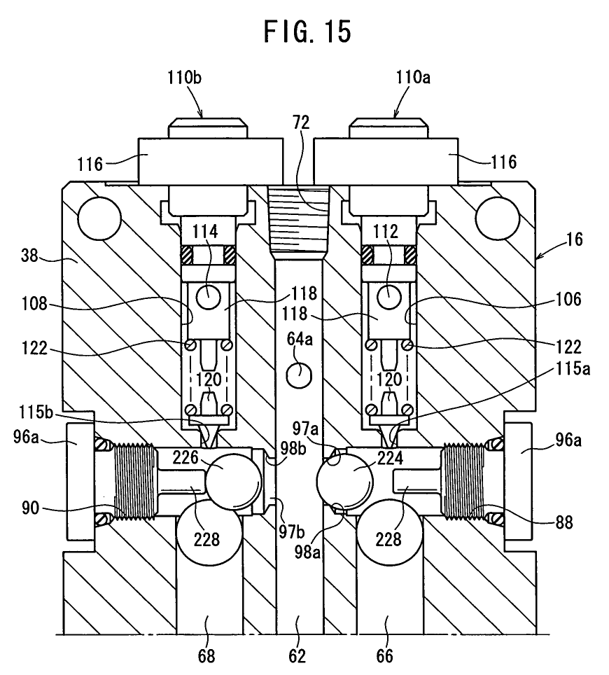

On the other hand, the first and second valves 92, 94, of the switching mechanism 70 need not necessarily be constructed as shuttle valves, having valve heads 100a, 100b and valve shafts 102a, 102b, as shown in FIG. 5. Spherical check valves, as shown in FIG. 15, may also be used. Such spherical first and second valves 224, 226 are disposed displaceably within the first and second installation holes 88, 90. Fastening sections 228, protruding toward the first and second valves 224, 226, are formed respectively on plugs 96a that seal the first and second installation holes 88, 90.

The following operation is effected when using the spherical first and second valves 224, 226. When pressure oil is supplied to the first or second passage 66, 68, the first or second valve 224, 226 is seated on the inner wall surface 98a, 98b of the first or second installation hole 88, 90, as a result of the pressure of the pressure oil, thereby blocking communication between the supply passage 62 and the first or second passage 66, 68. When pressure oil contained in the first or second passage 66, 68 is sucked by the pump mechanism 16, the first or second valve 224, 226 separates away from the inner wall surface 98a, 98b, whereby the first or second passage 66, 68 communicates with the supply passage 62. In other words, the first valve 224 and the second valve 226 are displaceable independently of each other.

When each of the first and second valves 224, 226 separates away from the inner wall surface 98a, 98b, displacement thereof is regulated by the fastening section 228.

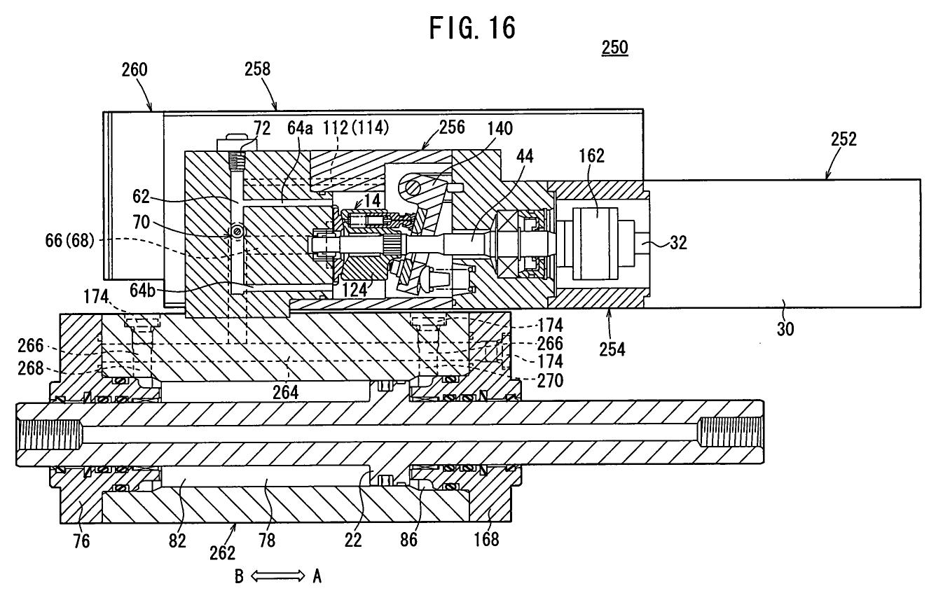

Next, an actuator 250 according to a second embodiment is shown in FIG. 16. The same constitutive components as those of the actuator 10 according to the first embodiment are designated using the same reference numerals, and detailed explanations thereof shall be omitted.

The actuator 250 according to the second embodiment differs from the actuator 10 of the first embodiment in that a driving section 252, a coupling section 254, and a pump mechanism 256 are all arranged coaxially. Further, a pump cover 258 for covering the pump mechanism 256 is provided with a cooling unit 260 therein for cooling the pump mechanism 256. A cylinder mechanism 262 is provided on one side of the pump mechanism 256 substantially in parallel therewith.

In the actuator 250, the coupling member 162 of the coupling section 254 is connected to the drive shaft 32 of the rotary driving source 30 that makes up the driving section 252. Further, the rotary shaft 44 of the pump mechanism 256 is connected to the coupling member 162. More specifically, the rotary driving source 30, the coupling member 162, and the rotary shaft 44 are arranged coaxially.

A box-shaped pump cover 258 is provided to cover outer portions of the pump mechanism 256 and the coupling section 254. The pump cover 258 includes a cooling unit 260 arranged on an end surface on one side of the pump mechanism 256. The cooling unit 260 is composed of, for example, a cooling fan, which is driven and rotated by a current supplied thereto. By rotating the cooling fan, air is blown to cool the pump mechanism 256.

The cylinder tube 78 making up the cylinder mechanism 262 is integrally formed, for example, by means of extrusion molding, in which an aluminum alloy is extruded in an axial direction. The cylinder tube 78 includes a pair of first through-holes 264 therein which penetrate substantially in parallel to the axis of the cylinder tube 78, together with a pair of second through-holes 266, which are substantially perpendicular to the first through-holes 264 and which communicate with the first and second cylinder chambers 82, 86 respectively. More specifically, the first and second through-holes 264, 266 intersect and communicate with each other, wherein ends of the first and second through-holes 264, 266 are sealed by plugs 174, thereby functioning as first and second cylinder passages 268, 270 providing communication between the first and second passages 66, 68 in the pump mechanism 256 and the first and second cylinder chambers 82, 86.

As described above, the actuator 250 according to the second embodiment has a cooling unit 260 provided at a position adjacent to the pump mechanism 256 to effect cooling. Accordingly, an increase in temperature caused by heat generated when the pump mechanism 256 is driven, can be appropriately avoided. In particular, it is preferable that the cooling unit 260 be provided in the vicinity of the relief valves 110a, 110b of the pump mechanism 256.

A increase in temperature in the vicinity of the pump mechanism 256 can be detected by an unillustrated temperature-detecting section (for example, a temperature sensor), whereby an amount of the current supplied from an unillustrated control unit to the cooling unit 260 can be controlled on the basis of the detection signal. Accordingly, the cooling unit 260 can be driven depending on a detected temperature in the vicinity of the pump mechanism 256. Therefore, it is possible to cool the pump mechanism 256 more efficiently.

When the driving section 252 and pump mechanism 256 are arranged coaxially, a small size in the widthwise dimension of the actuator 250, substantially perpendicular to the axis of the driving section 252, can be realized.

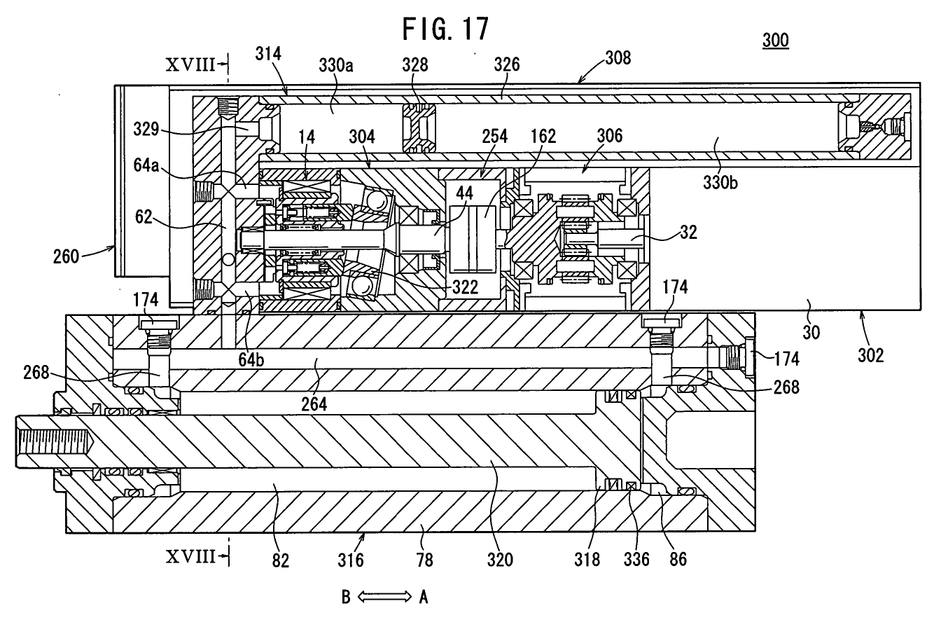

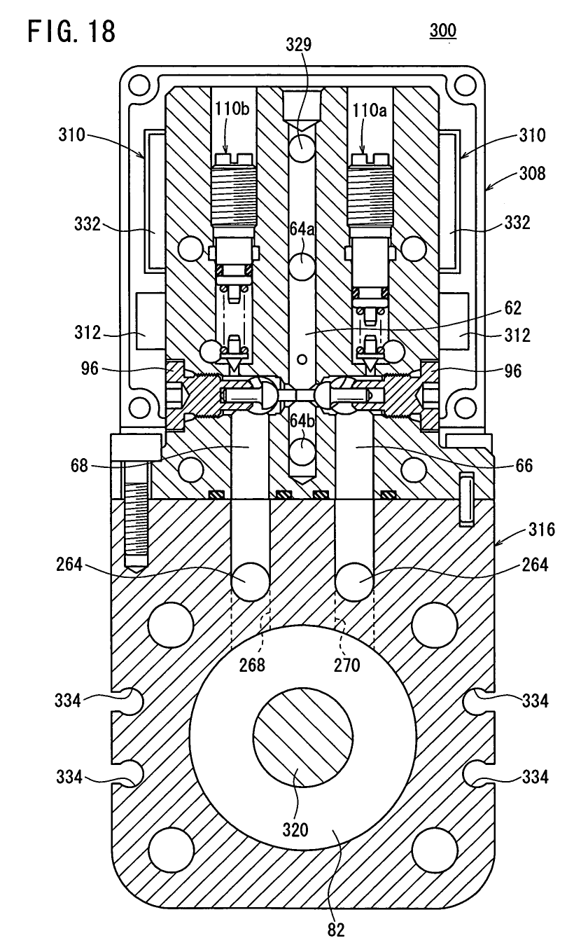

Next, an actuator 300 according to a third embodiment is shown in FIGS. 17 and 18. The same constitutive components as those of the actuators 10, 250 according to the first and second embodiments above are designated using the same reference numerals, and detailed explanations thereof shall be omitted.

The actuator 300 according to the third embodiment differs from the actuator 250 according to the second embodiment in that a speed change mechanism 306, which accelerates/decelerates the rotational speed supplied from a driving section 302, is provided between the driving section 302 and a pump mechanism 304, and further, another cooling section 310 is provided in addition to the cooling unit 260 provided in a pump cover 308 as described above. In addition, a temperature-detecting section 312 (for example, a temperature sensor) is provided for detecting the temperature in the vicinity of the pump mechanism 304, and an accumulator 314 is arranged on side portions of the driving section 302 and the pump mechanism 304 in which a predetermined amount of the pressure oil is retained.

In the actuator 300, the speed change mechanism 306 is connected to the drive shaft 32 of the rotary driving source 30, and further, the speed change mechanism 306 is connected to the rotary shaft 44 of the pump mechanism 304. When a driving force of the rotary driving source 30 is transmitted to the speed change mechanism 306, the rotational speed of the drive shaft 32 is accelerated/decelerated by the speed change mechanism 306 to a desired rotational speed, which is then transmitted to the pump mechanism 304 through the rotary shaft 44.

More specifically, the rotational speed of the cylinder block 124 is accelerated/decelerated by the speed change mechanism 304 by effecting a speed change on the rotary shaft 44. The discharge amount of pressure oil supplied to a cylinder mechanism 316 can be freely adjusted by the suction/discharge section 14. Therefore, the displacement speed and displacement force (thrust force) of the piston 318 and piston rod 320 of the cylinder mechanism 316 can also be freely adjusted.

An inclined member 322 is secured to a side surface on one side of the end block 38 in the pump body 36. The pump pistons 74 are inclined at a substantially constant angle with respect to the side surface. With this arrangement, the pump pistons 74 are driven and rotated by the driving force supplied from the driving section 302, while subjected to a guiding action of the inclined member 322. Pressure oil charged in the pressure oil-charging chamber 40 is supplied to the first or second cylinder chamber 82, 86 of the cylinder mechanism 316 via the first or second passage 66, 68. When the piston 318 is displaced in the axial direction inside the cylinder tube 78 under a pressing action effected by the pressure oil, pressure oil sucked by the pump mechanism 304 is introduced from the first or second cylinder chamber 82, 86, via the first or second cylinder passage 80, 84, into the supply passage 62, and the pressure oil is introduced into the accumulator 314 via a communication passage 329.

The pump mechanism 304 comprises an axial pump. Accordingly, leakage of pressure oil from the pump mechanism 304 can be suppressed. Further, the pump pistons 74 can obtain a high volumetric efficiency. With this arrangement, since the inclined member 322 is provided in the pump mechanism 304 and the pump pistons 74 are displaced under a guiding action of the inclined member 322, the longitudinal dimension of the pump mechanism 304 can be made smaller, as compared with the pump mechanisms 16 and 256, each of which employs a tiltable member 140 therein (see FIGS. 1 and 16).

The accumulator 314 comprises an accumulator piston 328, which is displaceable inside of a cylindrical tube member 326. One cylinder chamber 330a, which is disposed on a side of one end surface of the accumulator piston 328, communicates with the communication passage 329. The other cylinder chamber 330b, which is disposed on the side of the other end surface of the accumulator piston 328, is closed. A pressure fluid (for example, a gas) is charged into the other cylinder chamber 330b.

When pressure oil is introduced into the cylinder chamber 330a of the accumulator 314, the accumulator piston 328 is displaced by a pressing force exerted by the pressure oil, in a direction to separate away from the communication passage 329 (in the direction of the arrow A), and pressure oil is charged and retained in the cylinder chamber 330a.

As described above, a portion of the pressure oil supplied from the pump mechanism 304 to the cylinder mechanism 316 via the first or second passage 66, 68 is recirculated and retained in the accumulator 314, via the supply passage 62, in accordance with an opening/closing action of the relief valve 110a, 110b. Therefore, the pressure in the first or second cylinder chamber 82, 86 of the cylinder mechanism 316 can be gradually lowered in slight amounts. Control can be performed such that the pressure of the pressure oil remains substantially constant, by driving and rotating the pump mechanism 304 at a lower rotational speed, as compared to driving the cylinder mechanism 316 in a conventional manner.

On the other hand, the cooling section 310 provided in the pump cover 308 shown in FIG. 18 may be composed of a Peltier element 332, for example, which consists of a semiconductor element capable of effecting cooling control by applying a current thereto. The Peltier element 332 is arranged in the pump cover 308 and current is supplied to the Peltier element 332. Accordingly, the pump mechanism 304 is cooled by means of an endothermic reaction of the Peltier element 332. As described above, the pump mechanism 304 may also be cooled using a cooling unit 260 composed of a cooling fan or the like (see FIG. 17) together with the Peltier element 332. Therefore, increases in temperature, which would otherwise be caused by heat generated when the pump mechanism 304 is driven, can be avoided.

The Peltier element 332 can be converted from providing cooling control to heating control, by switching the current supplied to the Peltier element 332. Therefore, for example, when the temperature of the pressure oil is low in the pump mechanism 304, the pressure oil can be warmed by the Peltier element 332 as well. Accordingly, pressure oil having a large viscosity at low temperatures can be warmed to decrease the viscosity thereof. Therefore, the pump mechanism 304 can be smoothly driven with pressure oil having a small viscosity.

That is, when a Peltier element 332 is used as the cooling section 310, a single Peltier element 332 can be used to perform converse temperature control operations of cooling and heating for the pump mechanism 304.

The temperature-detecting section 312, comprising a temperature sensor, is disposed in the pump cover 308. Atmospheric temperature in the vicinity of the pump mechanism 304 is detected by the temperature-detecting section 312. A current supply state for the Peltier element 332 and/or the cooling unit 260 is controlled through an unillustrated control unit, on the basis of the detection result. Accordingly, temperature can be controlled, so that cooling is effected depending on an increase in temperature caused by generation of heat within the pump mechanism 304. Therefore, the pump mechanism 304 can be driven continuously at a substantially constant temperature.

As shown in FIG. 18, plural pairs of grooves 334 are formed in the axial direction on side surfaces of the cylinder tube 78. An unillustrated position detector (for example, a magnetic sensor) can be installed in the grooves 334. Accordingly, when a magnetic member 336 (for example, a permanent magnet, as shown in FIG. 17) is provided on an outer circumferential surface of the piston 318, the magnetic member 336 can be detected by the position detector in order to confirm a displacement position of the piston 318 in the axial direction.

Although certain preferred embodiments of the present invention have been shown and described in detail, it should be understood that various changes and modifications may be made therein without departing from the scope of the appended claims.

What is claimed is:

1. An actuator comprising:
a driving section driven and rotated by an electric signal;
a pump mechanism that sucks and discharges a pressure fluid by means of a driving force of said driving section;
a driving mechanism having a pair of chambers therein for receiving said pressure fluid from said pump mechanism, and including a displacement member displaceable in an axial direction under a pressing action effected by said pressure fluid;
a pair of flow passages formed between said pump mechanism and said pair of chambers of said driving mechanism, respectively, wherein said pressure fluid flows therethrough;
a switching mechanism provided in a connecting passage that interconnects said pair of flow passages, said switching mechanism being displaceable along said connecting passage depending on a pressure difference of said pressure fluid between one passage and another passage, to switch a communication state between one of said pair of flow passages and a retaining section that retains said pressure fluid therein; and
a throttle section provided between said pair of flow passages and said retaining section, which throttles a flow rate of said pressure fluid flowing from said flow passage to said retaining section,
wherein said pump mechanism, said driving mechanism, said pair of flow passages, said switching mechanism, and said throttle section are integrally constructed to provide a closed circuit through which said pressure fluid flows, and wherein said driving section to which said electric signal is applied is controlled by an open circuit.

2. The actuator according to claim 1, wherein a pressure-increasing mechanism, for increasing a pressure of said pressure fluid circulated from said driving mechanism to said retaining section, is disposed in said retaining section or between said retaining section and said connecting passage.

3. The actuator according to claim 2, wherein said driving section comprises an AC servo motor, said driving section being controlled in said open circuit by setting a restriction value of a number of revolutions, and setting a restriction value of a driving force of said AC servo motor.

4. The actuator according to claim 3, wherein said switching mechanism comprises a selector valve, said selector valve being opened and closed by said pressure of said pressure fluid that flows through said flow passage, in order to switch said communication state between said flow passage and said retaining section.

5. The actuator according to claim 4, wherein said pump mechanism includes relief valves therein, which are opened/closed by said pressure of said pressure fluid, thereby providing communication between said flow passages and said retaining section via return passages.

6. The actuator according to claim 5, wherein said relief valves are provided with bypass passages therein, communicating between said flow passages and said return passages.

7. The actuator according to claim 1, wherein a bypass passage, communicating between said flow passages, is provided between one flow passage and another flow passage, and wherein said throttle section is provided within said bypass passage.

8. The actuator according to claim 7, wherein said throttle section comprises a filter disposed on an upstream side with respect to a direction of flow of said pressure fluid.

9. The actuator according to claim 8, wherein said throttle section comprises one of a choke throttle and an orifice, said choke throttle having a reduced diameter with respect to a passage through which said pressure fluid flows and extending a predetermined length along said passage, said orifice having a reduced diameter with respect to said passage and having a longitudinal dimension smaller than that of said choke throttle.

10. The actuator according to claim 1, wherein said pair of flow passages and said connecting passages are formed in at least one of said pump mechanism and said driving mechanism.

11. The actuator according to claim 10, wherein said pressure fluid comprises a high viscosity synthetic oil having a high viscosity index, and exhibiting only slight changes in viscosity.

12. The actuator according to claim 10, wherein said pressure fluid comprises a silicone oil.

13. The actuator according to claim 1, wherein said pump mechanism comprises an axial pump having a plurality of pump pistons disposed in a cylinder block and arranged circumferentially with respect to a rotary shaft connected to said driving section, wherein said pump pistons engage with an inclined member having an inclined surface fixed in said pump mechanism, said pump pistons being displaceable in said axial direction by a rotary action of said cylinder block to thereby discharge and suck said pressure fluid.

14. The actuator according to claim 13, wherein a speed change mechanism, for providing transmission to said pump mechanism while controlling a rotary driving amount transmitted from said driving section, is provided between said pump mechanism and said driving section.

15. The actuator according to claim 14, wherein said pump mechanism comprises a cooling unit for cooling said pump mechanism.

16. The actuator according to claim 15, wherein said pump mechanism comprises a semiconductor element capable of controlling heating and cooling of said pump mechanism by application of electric power thereto.

17. The actuator according to claim 16, wherein said pump mechanism comprises a temperature detector for detecting an atmospheric temperature in the vicinity of said pump mechanism, wherein temperature control is performed by means of said cooling unit and said semiconductor element on the basis of said atmospheric temperature detected by said temperature detector.

18. The actuator according to claim 1, wherein said pump mechanism comprises an axial pump having a plurality of pump pistons disposed in a cylinder block and arranged circumferentially with respect to a rotary shaft connected to said driving section, wherein said pump pistons are engaged with a tiltable member provided tiltably in said pump mechanism, said pump pistons being displaceable in said axial direction by a rotary action of said cylinder block to thereby discharge and suck said pressure fluid.

19. The actuator according to claim 18, wherein said pump mechanism comprises a cooling unit for cooling said pump mechanism.
